(19) United States
(12) Patent Application Publication
(10) Pub. No.: US 2024/0173192 A1
(43) Pub. Date: May 30, 2024

(54) MOTION ASSISTANCE APPARATUS

(71) Applicant: SAMSUNG ELECTRONICS CO., LTD., Suwon-si (KR)

(72) Inventors: Jaehong KIM, Suwon-si (KR); Minhyung LEE, Suwon-si (KR); Seungyong HYUNG, Suwon-si (KR); Byungjune CHOI, Suwon-si (KR)

(21) Appl. No.: 18/432,428

(22) Filed: Feb. 5, 2024

Related U.S. Application Data
(63) Continuation of application No. PCT/KR2022/011191, filed on Jul. 29, 2022.

(30) Foreign Application Priority Data
Aug. 3, 2021 (KR) 10-2021-0102003
Jul. 8, 2022 (KR) 10-2022-0084355

(51) Int. Cl. A61H 1/02; A61H 3/00

(52) U.S. Cl. CPC A61H 1/0237; A61H 2003/007; A61H 2201/0107; A61H 2201/0192; A61H 2201/1269; A61H 2201/1673

(57) ABSTRACT

A wearable motion assistance apparatus may include: a waist plate positioned on a rear surface of a user's waist; a base frame extending from opposite ends of the waist plate and capable of accommodating a user's lumbar part therein; a main belt mounted on the base frame and capable of surrounding a user's abdomen; and a main band which is connected to the main belt and may be brought into elastic close contact with the user's lumbar part.

### CROSS-REFERENCE TO RELATED APPLICATIONS

This application is a continuation application of International Application No. PCT/KR2022/011191 designating the United States, filed on Jul. 29, 2022, in the Korean Intellectual Property Receiving Office and claiming priority to Korean Patent Application No. 10-2021-0102003, filed on Aug. 3, 2021, and Korean Patent Application No. 10-2022-0084355, filed on Jul. 8, 2022, in the Korean Intellectual Property Office, the disclosures of which are all hereby incorporated by reference herein in their entireties.

### BACKGROUND

### 1. Field

An example embodiment relates to a wearable device and/or an operating method thereof.

### 2. Description of Related Art

In a rapidly aging society, a growing number of people are complaining of joint-related inconvenience and pain. Accordingly, there is a heightened interest in assistance apparatuses that help the elderly or patients having joint problems to walk comfortably and/or to exercise.

There is a need for assistance apparatuses for improving the wearability and usability of wearable assistance apparatuses or walking assistance apparatuses that may assist pedestrians when walking and/or for exercise.

The above description is information the inventor acquired during the course of conceiving the present disclosure, or already possessed at the time, and was not necessarily publicly known before the present application was filed.

### SUMMARY

An aspect according to an example embodiment is to provide a motion assistance apparatus that may prevent or reduce downward displacement.

An aspect according to an example embodiment is to provide a motion assistance apparatus that may improve wearability of the motion assistance apparatus worn at least on the waist part of a user.

An aspect according to an example embodiment is to provide a motion assistance apparatus that is easily worn and/or removed.

According to an example embodiment, a motion assistance apparatus may include a waist plate positioned on, directly or indirectly, a rear surface of a waist of a user, a base frame extending from opposite ends of the waist plate and configured to accommodate a lumbar part of the user therein, a main belt mounted on, directly or indirectly, the base frame and configured to wrap around an abdomen of the user, and a main band connected, directly or indirectly, to the main belt and closely fitting the lumbar part of the user with elasticity.

According to an example embodiment, there may be provided a method of a wearable motion assistance apparatus worn by a user, the method comprising: a waist plate of the wearable motion assistance apparatus positioned on at least a rear of a waist of a user; a base frame of the wearable motion assistance apparatus extending from opposite ends of the waist plate and accommodating at least part of a lumbar part of the user; a main belt of the wearable motion assistance apparatus mounted on the base frame and wrapped at least partially around an abdomen of the user; and a main band of the wearable motion assistance apparatus connected to the main belt and closely fitting the lumbar part of the user with elasticity.

The main band may be connected, directly or indirectly, to the waist plate and configured to space the base frame apart from the lumbar part of the user such that the base frame does not touch the lumbar part of the user.

The main belt may include a first main belt configured to wrap around a left abdomen of the user and a second main belt configured to wrap around a right abdomen of the user, wherein a length of the second main belt is equal to or different from a length of the first main belt, and the main band may include a first main band configured to connect the first main belt to the waist plate and a second main band configured to connect the second main belt to the waist plate.

The main band may be configured to cause the main belt to open and/or close by applying tension to the main belt.

The main band may be elastically deformed by the waist of the user and configured to apply tension to a predetermined part of the main belt in a first state in which the main belt is open.

According to an example embodiment, the motion assistance apparatus may further include a bistable spring provided inside the main belt and maintained in one of two stable states through resilience.

The main band may be configured to deform the bistable spring from a first stable state, which is a shape that extends straight in a longitudinal direction, to a second stable state, which is a shape with one bend.

The main belt may be in a first state in which the main belt is open when the bistable spring is in the first stable state, and the main belt may be in a second state in which the main belt is closed when the bistable spring is in the second stable state.

The bistable spring may be deformed by tension applied by the main band from the first stable state to the second stable state, and the main belt may be deformed from the first state in which the main belt is open to the second state in which the main belt is closed.

The main belt may include at least one belt link that is connectable to the main band and at least one bending point that is bendable at a predetermined angle, and the bending point may be disposed between an end of the base frame and the belt link.

When the main belt is in the second state in which the main belt is closed, a portion of the first main belt may overlap a portion of the second main belt, and overlapping portions of the first main belt and the second main belt are attachable to or detachable from one another through an attachment element.

The length of the first main band and the length of the second main band are adjustable.

A motion assistance apparatus according to an example embodiment may prevent or reduce downward displacement.

A motion assistance apparatus according to an example embodiment may improve wearability of the motion assistance apparatus worn on the waist part of a user.

A motion assistance apparatus according to an example embodiment may be easily worn and removed.

### BRIEF DESCRIPTION OF DRAWINGS

The above and other aspects, features, and advantages of certain embodiments of the present disclosure will be more apparent from the following detailed description, taken in conjunction with the accompanying drawings, in which:

FIG. 1 is a schematic rear view of a motion assistance apparatus according to an example embodiment.

FIG. 2 is a left side view of a motion assistance apparatus worn by a user, according to an example embodiment.

FIGS. 3A and 3B are plan views of a motion assistance apparatus from above, according to an example embodiment.

FIG. 4A is an example perspective view illustrating a bistable spring in a first stable state and FIG. 4B is a perspective view illustrating the bistable spring in a second stable state.

FIG. 5 is an example graph schematically illustrating potential energy according to a displacement angle of a bistable spring.

FIG. 6 is a three-dimensional view of a waist plate, a main band, and a main belt of a motion assistance apparatus according to an example embodiment.

### DETAILED DESCRIPTION

Hereinafter, embodiments are described in detail with reference to the accompanying drawings. The following description describes one of several aspects of the embodiments, and the following description forms part of the detailed description of the embodiments. In the description of embodiments, detailed description of well-known related structures or functions is omitted when it is deemed that such description will cause ambiguous interpretation of the present disclosure.

However, various alterations and modifications may be made to the embodiments, and the embodiments are not construed as limited to the disclosure. The embodiments should be understood to include all changes, equivalents, and replacements within the idea and the technical scope of the disclosure.

In addition, the terms or words used to describe the present disclosure and claims should not be construed in a conventional or dictionary meaning, and based on a principle that the inventor may properly define the concept of terms in order to best describe example embodiments, the terms or words should be construed as having meanings and concepts consistent with the technical idea of the disclosure according to an embodiment.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, components, or combinations thereof, but do not preclude the presence or addition of one or more of other features, integers, steps, operations, elements, components, or combinations thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted 10 in an idealized or overly formal sense unless expressly so defined herein.

In addition, when describing the embodiments with reference to the accompanying drawings, like reference numerals refer to like elements and a repeated description related thereto will be omitted. In the description of the embodiments, any detailed description of well-known related structures or functions will be omitted when it is deemed that such description will cause ambiguous interpretation of the present disclosure.

In addition, terms such as first, second, A, B, (a), (b), and the like may be used to describe components of the embodiments. Each of these terms is not used to define an essence, order, or sequence of corresponding components, but used merely to distinguish the corresponding components from other components. It is to be understood that if a component is described as being “connected,” “coupled” or “joined” to another component, the former may be directly “connected,” “coupled,” and “joined” to the latter or “connected”, “coupled”, and “joined” to the latter via at least another component(s).

Components included in an embodiment and components having a common function are described using the same names in other embodiments. Unless disclosed to the contrary, the configuration disclosed in any one embodiment may be applied to other embodiment(s), and the specific description of the repeated configuration will be omitted.

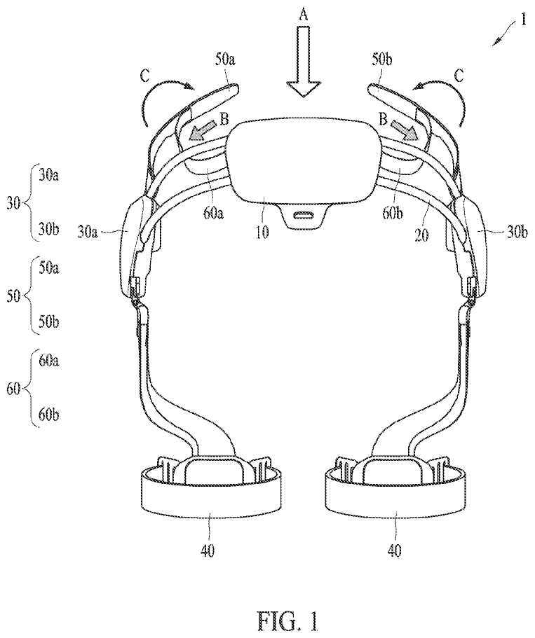

FIG. 1 is a schematic rear view of a motion assistance apparatus 1 according to an embodiment.

The motion assistance apparatus 1 according to an embodiment may be worn by a user and assist motion of the user. The motion of the user may include walking, running, weight training, and the like, but embodiments are not limited thereto. For example, the motion assistance apparatus 1 may support the body of the user by assisting motion of some of the joints of the lower body of the user. The motion assistance apparatus 1 may assist the motion of the user by supporting the joints or muscles of the waist, femoral region, calf, and the like.

Hereinafter, a description is provided based on the motion assistance apparatus 1 worn on the hip joint and waist part of the user to assist the user when walking, but the wearing location and purpose of the motion assistance apparatus 1 are not limited thereto.

Referring to FIG. 1, the motion assistance apparatus 1 according to an embodiment may include a waist plate 10, a base frame 20, control units 30a and 30b, a pair of arms 40, a main belt 50, and a main band 60. The body of the user may be inserted in direction A and positioned inside the motion assistance apparatus.

The waist plate 10 may be positioned on, directly or indirectly, the lumbar part (waist part) of the user while the user wears the motion assistance apparatus 1. The waist plate 10 may be mounted on, directly or indirectly, the lumbar part of the user to provide cushioning to the waist of the user and support the waist of the user. While the user wears the motion assistance apparatus 1, the waist plate 10 may be placed over the buttocks (hips) of the user to prevent or reduce a chance of the motion assistance apparatus 1 from being displaced downward due to gravity. While the user wears the motion assistance apparatus 1, the waist plate 10 may disperse some of the weight of the motion assistance apparatus 1 onto the waist of the user. The waist plate 10 may be connected, directly or indirectly, to the base frame 20. A base frame-connecting element (not shown) that may be connected, directly or indirectly, to the base frame 20 may be formed at the opposite ends of the waist plate 10.

“On” as used herein covers both directly on, and directly on with other element(s) therebetween.

The base frame 20 may extend from the opposite ends of the waist plate 10. The base frame 20 may accommodate the lumbar part of the user therein. The base frame may include at least one rigid body beam. Each beam may have a curved shape with a predetermined curvature to wrap around the lumbar part of the user. The main belt 50 may be connected, directly or indirectly, to an end of the base frame 20. A control unit 30 may be mounted on, directly or indirectly, the base frame 20. The base frame 20 may include a control unit connector (not shown) to mount the control unit 30 thereon.

The control unit 30 may include a first unit 30a positioned on the left side of the user while the user wears the motion assistance apparatus 1 and a second unit 30b positioned on the right side of the user while the user wears the motion assistance apparatus 1. The control unit 30 may be mounted on, directly or indirectly, and fixed to the base frame 20. The control unit 30 may transmit power to the pair of arms 40. The control unit 30 may include an electronic device (not shown) for controlling the power transmitted to the pair of arms 40. The control unit 30 may be positioned on the side of the femoral region or the side of the lumber part of the user or positioned between the side of the femoral region and the side of the lumber part of the user.

The pair of arms 40 may be worn on both legs of the user. The pair of arms 40 may receive the power from the control unit 30 to apply pressure to the legs of the user in a direction that assists the motion of the femoral regions, knees, calves, and the like of the user. The pair of arms 40 may include a support unit that wraps around the legs of the user and a connecting frame that connects the support unit to the control unit 30.

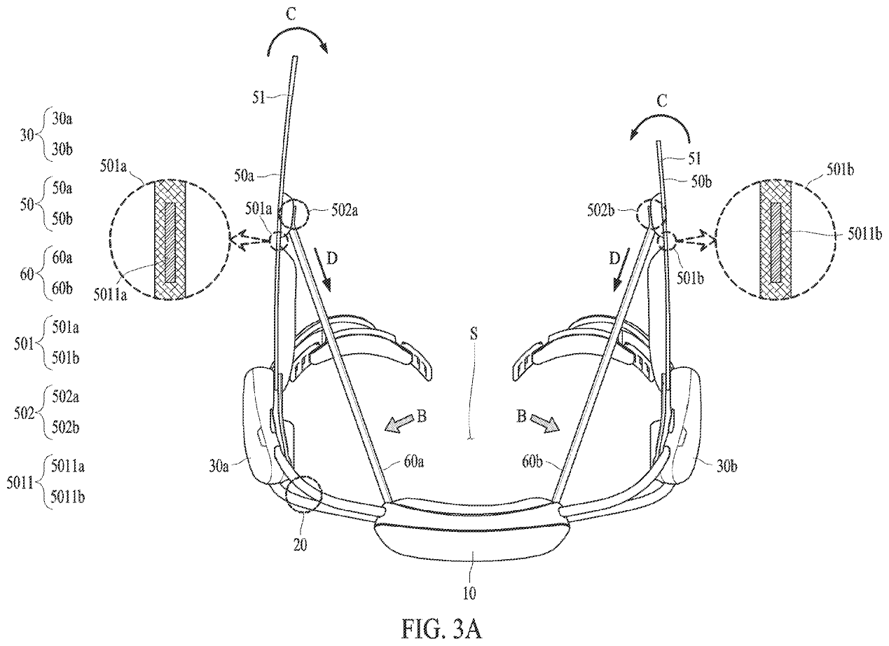

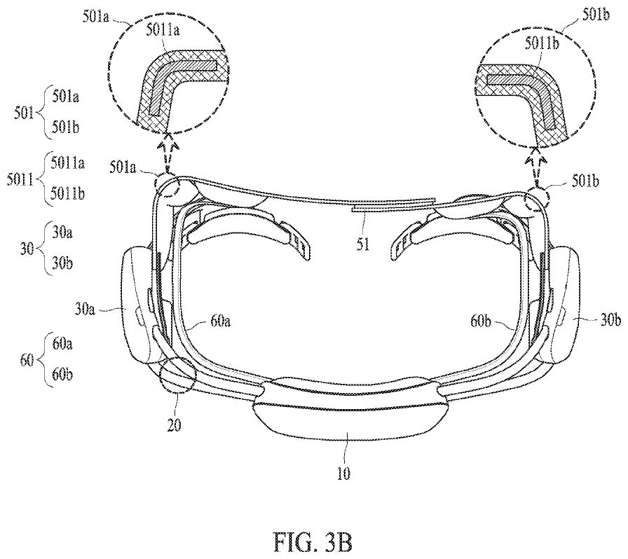

The main belt 50 may be connected, directly or indirectly, to the base frame 20. The main belt 50 may include a first main belt 50a that may wrap around the left abdomen of the user while the user wears the motion assistance apparatus 1 and a second main belt 50b that may wrap around the right abdomen of the user while the user wears the motions assistance apparatus 1. The first main belt 50a may be longer than the second main belt 50b, but embodiments are not limited thereto, and the length of the first main belt 50a may be the same or shorter than the length of the second main belt 50b. The first main belt 50a and the second main belt 50b may be connected, directly or indirectly, to the opposite ends of the base frame 20, respectively. When the body of the user is inserted in direction A in which the body is accommodated in the motion assistance apparatus 1, the main belt 50 may be bent in direction C in which the main belt wraps around the abdomen of the user. While the user wears the motion assistance apparatus 1, the first main belt 50a and the second main belt 50b may be connected, directly or indirectly, to each other. The main belt 50 may be connected, directly or indirectly, to the main band 60. While the user wears the motion assistance apparatus 1, the main belt 50 may disperse some of the weight of the motion assistance apparatus 1 onto the abdomen of the user. The main belt 50 may include a bistable spring (not shown) that is provided inside the main belt and maintained in one of two stable states through resilience. A description of the placement of the stable spring (not shown) on the main belt 50 and more detailed information on the shape of the stable spring are provided in detail with reference to FIGS. 3A to 5.

The main band 60 may include a first main band 60a that may wrap around the left side of the lumbar part of the user while the user wears the motion assistance apparatus 1 and a second main band 60b that may wrap around the right side of the lumbar part of the user while the user wears the motion assistance apparatus 1. An end of the first main band 60a may be connected, directly or indirectly, to the first main belt 50a. The other end of the first main band 60a may be connected, directly or indirectly, to the waist plate 10. An end of the second main band 60b may be connected, directly or indirectly, to the second main belt 50b. The other end of the second main band 60b may be connected, directly or indirectly, to the waist plate 10. The main band 60 may be elastically deformed with elasticity. When the user is inserted in direction A in which the user is accommodated in the motion assistance apparatus 1, the main band 60 may stretch B to match the shape of the waist of the user.

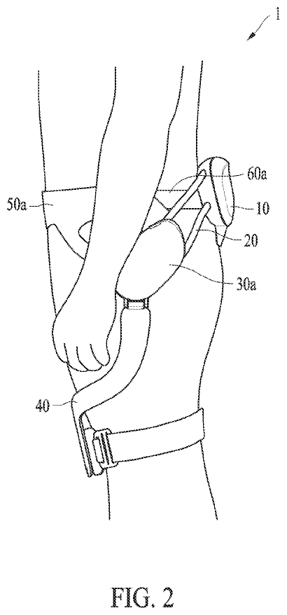

FIG. 2 is a left side view of the motion assistance apparatus 1 worn by a user, according to an embodiment.

Referring to FIG. 2, the waist plate 10 may be mounted on, directly or indirectly, the lumbar part of the user and placed over the buttocks of the user to support some of the weight of the motion assistance apparatus 1. The first control unit 30a may be disposed on the left side of the lumbar part of the user. The base frame 20 may extend from an end of the waist plate 10 and be inclined in the direction towards the control unit 30a. The first main belt 50a mounted on, directly or indirectly, the base frame 20 may wrap around the left abdomen of the user. An arm 40 may be mounted on, directly or indirectly, a leg of the user and receive power from the control unit.

The first main band 60a connected, directly or indirectly, to the waist plate 10 and the first main belt 50a may closely fit the left side of the lumbar part of the user. The first main band 60a that closely fits the left side of the lumbar part of the user may stretch due to elastic deformation. The first main band 60a closely fits the waist of the user with elasticity, improving the wearability and preventing or reducing chances of the motion assistance apparatus 1 from being displaced downward due to the weight of the motion assistance apparatus.

In addition, due to the first main band 60a that wraps around the lumbar part of the user, the lumbar part of the user may not directly touch the base frame 20. Therefore, the waist of the user rotates or undergoes parallel movement within the base frame 20, thereby reducing direct contact between the base frame 20, which is a rigid body, and the abdomen of the user. In other words, the pressure on the abdomen caused by movement (e.g., rotational movement) of the body of the user within the base frame 20 may be eliminated or reduced. When the body of the user rotates or undergoes parallel movement within the base frame 20, the first main band 60a may prevent or reduce chances of the body of the user from directly touching the base frame 20 by elastically stretching or contracting in response to the motion of the user.

Although FIG. 2 illustrates the left side of the motion assistance apparatus 1 worn on the body of the user, those skilled in the art may clearly understand that the above description may also apply to the right side of the body of the user.

FIGS. 3A and 3B are plan views of a motion assistance apparatus from above, according to an embodiment.

Particularly, FIG. 3A illustrates the motion assistance apparatus 1 in a first state in which the main belt 50 is unfastened.

Referring to FIG. 3A, the main belt 50 may include at least one main belt link 502 connected, directly or indirectly, to the main band 60. The first main belt 50a may include a first main belt link 502a connected, directly or indirectly, to the first main band 60a, and the second main belt 50b may include a second main belt link 502b connected, directly or indirectly, to the second main band 60b. The first main band 60a may extend from the waist plate 10 to the first main belt link 502a, and the second main band 60b may extend from the waist plate 10 to the second main belt link 502b.

When the body of a user is accommodated in a space S in the main frame 20, the lumbar part of the user may touch and apply pressure to the first main band 60a and the second main band 60b in direction B in which each main band stretches. The first main band 60a and the second main band 60b pressurized by the waist of the user may exhibit tension D in the direction towards the body of the user. The tension may pull a belt link of each of the first main belt 50a and the second main belt 50b in direction B towards the body of the user.

A bistable spring 5011 may be provided in the main belt 50 and maintained in one of two stable states through resilience. The two stable states may include a “first state” in which the bistable spring 5011 has a shape that extends straight in its longitudinal direction and a “second state” in which the bistable spring 5011 has a shape with one bend.

The shape of the main belt 50 may be determined according to the shape of the bistable spring 5011. For example, a main belt may be maintained in a first state in which the main belt is unfastened when the bistable spring 5011 is in the “first stable state”, and the main belt may be maintained in a second state in which the main belt is closed when the bistable spring 5011 is in the “second stable state”.

The bistable spring 5011 may include a first bistable spring 5011a disposed in the first main belt 50a and a second bistable spring 5011b disposed in the second main belt 50b. Each of the bistable springs (e.g., 5011a and 5011b) may be deformed from the first stable state to the second stable state to bend each of the first main belt 50a and the second main belt 50b in the direction that wraps around the body of the user.

The bistable spring 5011 may receive the tension of the main band 60 and then be deformed from the first stable state to the second stable state. In other words, when a predetermined amount of tension or greater is applied to the first main belt link 502a and the second main belt link 502b, the first main belt 50a and the second main belt 50b may be bent in direction C that wraps around the abdomen of the user. The main belt 50 may include at least one bending point 501 that is bendable at a predetermined angle. The first main belt 50a may include a first bending point 501a disposed between an end of the base frame 20 and the first main belt link 502a. The second main belt 50b may include a second bending point 501b disposed between an end of the base frame 20 and the second main belt link 502b. The location of each bending point 501 may vary between the end of the base frame and each of the belt links. In this case, the first bistable spring 5011a and the second bistable spring 5011b may be disposed at the location of the first bending point 501a and the second bending point 501b, respectively.

When the body of the user is accommodated in the space S in the main frame 20 and tension is applied to each of the belt links, bending load may be generated at each of the bending points (e.g., 501a and 501b). When the intensity of the bending load exceeds a predetermined numerical value, the shape of a bistable spring disposed at a bending point may be deformed from the first stable state to the second stable state, and accordingly, each of the bending points may be bent. As a result, the shape of the main belt may be deformed to the second state in which the main belt wraps around the abdomen of the user.

The first main belt 50a may be longer than the second main belt 50b. An end of the first main belt 50a and an end of the second main belt 50b may each have an attachment element 51 such that the first main belt 50a and the second main belt 50b are attached to each other.

FIG. 3B illustrates a motion assistance apparatus in the second state in which a main belt is closed.

Referring to FIG. 3B, as the bistable spring 5011 is in the second stable state, the first main belt is bent at the first bending point 501a and the second main belt is bent at the second bending point 501b, and accordingly, the main belt may be deformed to the second state in which the main belt is closed to wrap around the body of the user.

In a state in which each of the first main belt and the second main belt is bent, an end of the first main belt may overlap an end of the second main belt. The attachment element 51 may fix the main belt by attaching overlapping portions of the first main belt and the second main belt to one another such that the main belt is not arbitrarily unfastened. The first main band 60a and the second main band 60b may be elastically deformed corresponding to the shape of the lumbar part and the abdomen of the user and, when deformed, may closely fit and wrap around the lumbar part and the abdomen of the user. The first main band 60a and the second main band 60b may reduce pressure applied by the base frame 20 to the body of the user by creating a space between the body of the user, accommodated in the base frame 20, and the base frame 20.

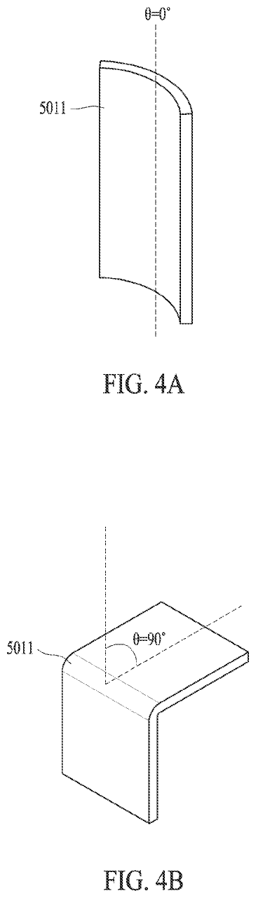

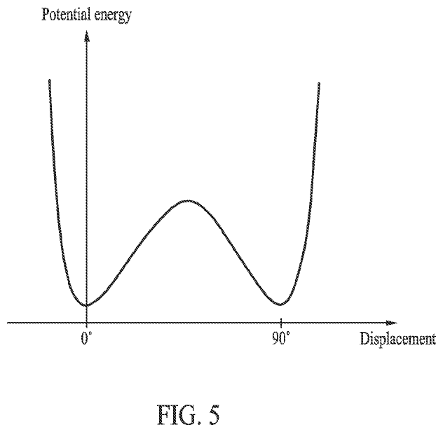

FIG. 4A is a perspective view illustrating a bistable spring in a first stable state, FIG. 4B is a perspective view illustrating the bistable spring in a second stable state, and FIG. 5 is a graph schematically illustrating potential energy according to a displacement angle of a bistable spring.

Referring to FIGS. 4A to 5, the bistable spring 5011 in the “first stable state” may have a shape that is curved in the direction perpendicular to its longitudinal direction. While switching from the “first stable state” into the “second stable state”, the bistable spring 5011 may be deformed such that the curvature of the curved shape is reduced. In other words, the bistable spring 5011 in the “second stable state” may have a shape that is relatively flat except for the curved portion.

A state in which the angle of the bistable spring 5011 is 0 degrees based on its longitudinal direction and a state in which the angle of the bistable spring is 90 degrees based on its longitudinal direction may each correspond to a point at which potential energy is the smallest and may be illustrated as the “first stable state” and the “second stable state”, respectively. However, the angle at which a bistable spring is in a stable state is not limited to 0 or 90 degrees, and the angle may be implemented in various degrees depending on the material or shape of the bistable spring.

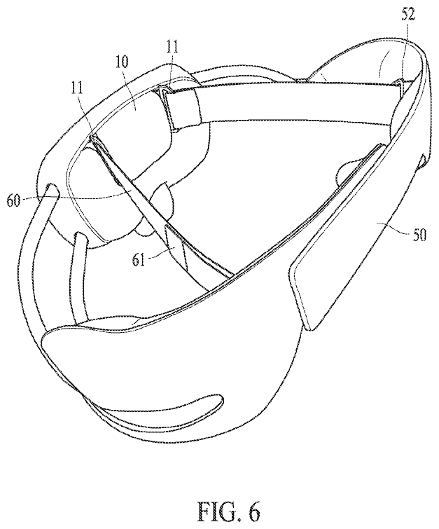

FIG. 6 is a three-dimensional view of the waist plate 10, the main band 60, and the main belt 50 of a motion assistance apparatus according to an embodiment.

Referring to FIG. 6, the waist plate 10 may include a first link element 11 that may be connected, directly or indirectly, to the main band 60. The first link element 11 may be provided in a pair that corresponds to the main band 60.

The main belt 50 may include a second link element 52 that may be connected, directly or indirectly, to the main band 60. The second link element 52 may be provided in a pair that corresponds to the main band. The second link element 52 may be disposed on the main belt 50 at a portion corresponding to the main belt link described above of the main belt 50.

The first link element 11 and the second link element 52 may include a slit-shaped opening to which the main band may be attached. The shape of the first link element 11 and the shape of the second link element 52 are not limited to the illustration of FIG. 6.

The length of the main band 60 may be adjusted corresponding to the body of the user. The main band 60 may include a length adjustment element 61 that may adjust its length. The length adjustment element 61 may be an adhesive such as a hook-and-loop fastener, but embodiments are not limited thereto. Embodiments have been described above with reference to specific matters such as specific components and limited embodiments and with reference to drawings, but these are provided to facilitate overall understanding. Also, the present disclosure is not limited to the above-described embodiments, and various modifications and variations are possible from these descriptions by those skilled in the art to which the present disclosure pertains. Therefore, the scope of the disclosure is defined not by the detailed description, but by the claims and their equivalents, and all variations within the scope of the claims and their equivalents are to be construed as being included in the disclosure. While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

1. A wearable motion assistance apparatus comprising:
a waist plate configured to be positioned on at least a rear of a waist of a user;
a base frame extending from opposite ends of the waist plate and configured to accommodate at least part of a lumbar part of the user;
a main belt mounted on the base frame and configured to wrap at least partially around an abdomen of the user; and
a main band connected to the main belt and configured to closely fit the lumbar part of the user with elasticity.

2. The motion assistance apparatus of claim 1, wherein the main band is connected to the waist plate and configured to space the base frame apart from the lumbar part of the user such that the base frame is configured so as to not touch the lumbar part of the user.

3. The motion assistance apparatus of claim 2, wherein
the main belt comprises a first main belt configured to wrap around a left abdomen of the user and a second main belt configured to wrap around a right abdomen of the user, wherein a length of the second main belt is equal to or different from a length of the first main belt, and
the main band comprises a first main band configured to connect the first main belt to the waist plate and a second main band configured to connect the second main belt to the waist plate.

4. The motion assistance apparatus of claim 2, wherein the main band is configured to cause the main belt to open and close by applying tension to the main belt.

5. The motion assistance apparatus of claim 4, wherein the main band is configured to be elastically deformed by the waist of the user and configured to apply tension to a predetermined part of the main belt in a first state in which the main belt is open.

6. The motion assistance apparatus of claim 1, further comprising:
a bistable spring provided at least partially inside the main belt and maintained in one of two stable states through resilience.

7. The motion assistance apparatus of claim 6, wherein the main band is configured to deform the bistable spring from a first stable state, which is a shape that extends straight in a longitudinal direction, to a second stable state, which is a shape with one bend.

8. The motion assistance apparatus of claim 7, wherein the main belt is configured to be in a first state in which the main belt is open when the bistable spring is in the first stable state, and the main belt is configured to be in a second state in which the main belt is closed when the bistable spring is in the second stable state.

9. The motion assistance apparatus of claim 8, wherein the bistable spring is configured to be deformed by tension applied by the main band from the first stable state to the second stable state, and the main belt is configured to be deformed from the first state in which the main belt is open to the second state in which the main belt is closed.

10. The motion assistance apparatus of claim 1, wherein the main belt comprises at least one belt link that is connectable to the main band and at least one bending point that is bendable at a predetermined angle, and the bending point is disposed between an end of the base frame and the belt link.

11. The motion assistance apparatus of claim 3, wherein, when the main belt is in a second state in which the main belt is closed, a portion of the first main belt overlaps a portion of the second main belt, and overlapping portions of the first main belt and the second main belt are attachable to or detachable from one another through an attachment element.

12. The motion assistance apparatus of claim 3, wherein the length of the first main band and the length of the second main band are adjustable.

13. A method of a wearable motion assistance apparatus worn by a user, the method comprising:
a waist plate of the wearable motion assistance apparatus positioned on at least a rear of a waist of a user;
a base frame of the wearable motion assistance apparatus extending from opposite ends of the waist plate and accommodating at least part of a lumbar part of the user;
a main belt of the wearable motion assistance apparatus mounted on the base frame and wrapped at least partially around an abdomen of the user; and
a main band of the wearable motion assistance apparatus connected to the main belt and closely fitting the lumbar part of the user with elasticity.
